(19) United States
(12) Patent Application Publication
(10) Pub. No.: US 2022/0181876 A1
(43) Pub. Date: Jun. 9, 2022

(54) INFORMATION PROCESSING DEVICE, SERVER, AND PROGRAM

(71) Applicant: TOYOTA JIDOSHA KABUSHIKI KAISHA, Toyota-shi (JP)

(72) Inventors: Yuka SHIRAIWA, Fuji-shi (JP); Hirotaka SAITO, Sunto-gun (JP); Yuma MATSUMOTO, Susono-shi (JP); Takahiro UCHIDA, Susono-shi (JP); Shuji MORIYAMA, Susono-shi (JP)

(73) Assignee: TOYOTA JIDOSHA KABUSHIKI KAISHA, Toyota-shi (JP)

(21) Appl. No.: 17/544,397

(22) Filed: Dec. 7, 2021

(30) Foreign Application Priority Data
Dec. 9, 2020 (JP) 2020-204568

(51) Int. Cl. H02J 3/00; A63B 21/005; F03G 5/02; B60L 53/50

(52) U.S. Cl. CPC H02J 3/004; A63B 21/0055; B60W 20/20; B60L 53/50; F03G 5/025

(57) ABSTRACT

An information processing system includes a server including a first processor provided with hardware, and a power generation device including a second processor provided with hardware. The second processor executes power generation control that converts, into electric power, kinetic energy generated as a user operates an operation unit of the power generation device, and outputs, to the server, power generation information indicating a power generation amount generated by power generation under the power generation control. The first processor identifies the power generation information and user information indicating the user who operates the operation unit for the power generation of the power generation information, and assigns worth information indicating a worth corresponding to the power generation amount with respect to the identified user information.

### CROSS-REFERENCE TO RELATED APPLICATION

This application claims priority to Japanese Patent Application No. 2020-204568 filed on Dec. 9, 2020, incorporated herein by reference in its entirety.

### BACKGROUND

### 1. Technical Field

The present disclosure relates to an information processing device, a server, and a program.

### 2. Description of Related Art

Japanese Unexamined Patent Application Publication No. 2012-214174 (JP 2012-214174 A) discloses a vehicle in which a driver of the vehicle operates a pedal mechanism in the vehicle to generate electric power manually, and the generated electric power is used to rotate a power source to drive the vehicle.

### SUMMARY

In the configuration described in JP 2012-214174 A, the driver can have an opportunity to exercise while using the vehicle, and can also obtain electric power as compensation for the exercise. On the other hand, health-conscious people have a habit of going to a fitness gym and exercising using a machine such as a treadmill. For people with such exercise habits, when electric power is obtained as compensation for exercise, the configuration described in JP 2012-214174 A limits the opportunity to exercise to the case of using a vehicle, whereby convenience is reduced.

The present disclosure is made in view of the above circumstances, and an object of the present disclosure is to provide an information processing system, a server, and a program in which a user can obtain compensation for exercise by moving his/her body and performing exercise accompanied by power generation.

An information processing system according to the present disclosure includes: a server including a first processor provided with hardware; and a power generation device including a second processor provided with hardware. The second processor executes power generation control that converts, into electric power, kinetic energy generated as a user operates an operation unit of the power generation device, and outputs, to the server, power generation information indicating a power generation amount generated by power generation under the power generation control. The first processor identifies the power generation information and user information indicating the user who operates the operation unit for the power generation of the power generation information, and assigns worth information indicating a worth corresponding to the power generation amount with respect to the identified user information.

A server according to the present disclosure includes a processor provided with hardware. The processor identifies, for a power generation device that converts kinetic energy generated as a user operates an operation unit into electric power, power generation information indicating a power generation amount generated by the power generation device and user information indicating the user who operates the operation unit for the power generation of the power generation information, and assigns worth information indicating a worth corresponding to the power generation amount to the identified user information.

A program according to the present disclosure that causes a processor provided with hardware to execute: identification of, for a power generation device that converts kinetic energy generated as a user operates an operation unit into electric power, power generation information indicating a power generation amount generated by the power generation device and user information indicating the user who operates the operation unit for the power generation of the power generation information; and assignment of worth information indicating a worth corresponding to the power generation amount to the identified user information.

According to the present disclosure, the user can obtain compensation for exercise by moving his/her body and performing the exercise accompanied by power generation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a schematic configuration of an information processing system according to an embodiment;

FIG. 2 is a block diagram showing a functional block of the information processing system according to the embodiment;

FIG. 3 is a sequence diagram for explaining the overall processing flow;

FIG. 4 is a flowchart showing a process flow for a power generation device; and

FIG. 5 is a block diagram showing a functional block of an information processing system in a modification.

### DETAILED DESCRIPTION OF EMBODIMENTS

Hereinafter, an information processing system, a server, and a program according to an embodiment of the present disclosure will be specifically described with reference to the drawings. Further, the present disclosure is not limited to the embodiment described below.

### Information Processing System

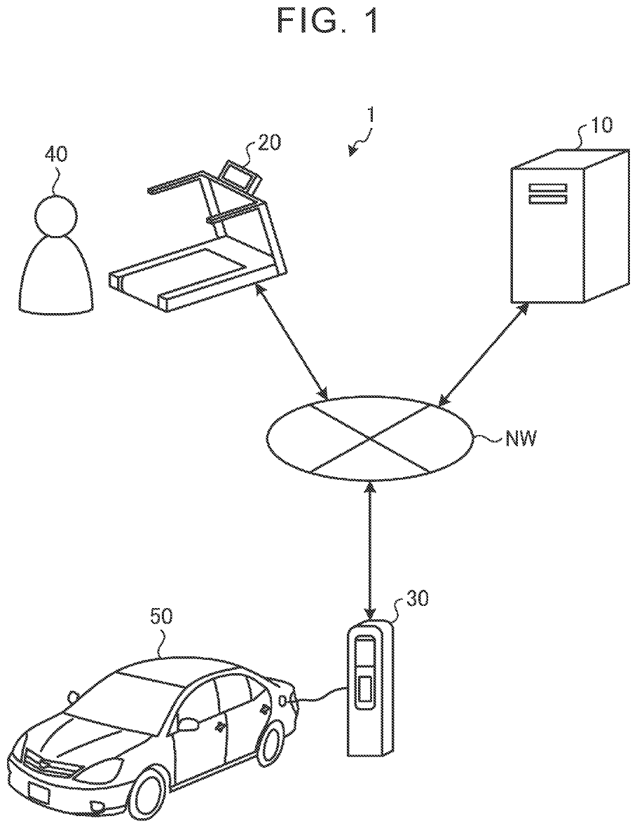

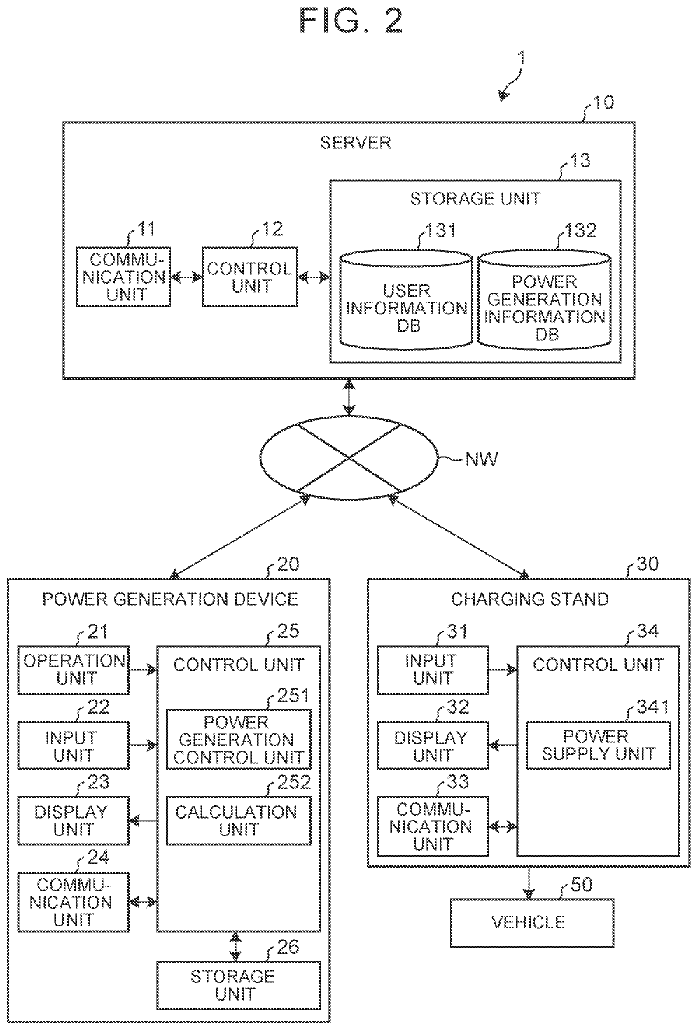

The configuration of an information processing system according to the embodiment will be described with reference to FIGS. 1 and 2. As shown in FIG. 1, the information processing system 1 includes a server 10, a power generation device 20, and a charging stand 30.

In the information processing system 1, the server 10, the power generation device 20, and the charging stand 30 are configured to be able to communicate with each other through a network NW. The network NW is composed of, for example, the Internet network and a mobile phone network.

The information processing system 1 is configured such that a user 40 uses the power generation device 20 to perform an exercise accompanied by power generation, and in return for this exercise, a vehicle 50 can obtain electric power that can be charged to the vehicle 50. The vehicle 50 is an electric vehicle provided with a motor as a power source. When the vehicle 50 is charged with electric power at the charging stand 30, electric power can be obtained as compensation for the exercise accompanied by power generation performed in advance. As described above, the information processing system 1 realizes an exercise promotion system that promotes the exercise of the user 40.

### Server

The server 10 is a management server for comprehensively managing the exercise promotion system, and is managed by an administrator of the exercise promotion system. As shown in FIG. 2, the server 10 includes a communication unit 11, a control unit 12, and a storage unit 13.

The communication unit 11 is, for example, a local area network (LAN) interface board or a wireless communication circuit for wireless communication. The communication unit 11 is connected to the network NW such as the Internet, which is a public communication network. Then, the communication unit 11 communicates with the power generation device 20 and the charging stand 30 by connecting to the network NW.

The control unit 12 includes a processor and a memory. The processor includes a central processing unit (CPU), a digital signal processor (DSP), a field-programmable gate array (FPGA), and the like. The memory is a main storage device, and includes a random access memory (RAM), a read-only memory (ROM), or the like. The control unit 12 loads the program stored in the storage unit 13 into the work area of the memory (main storage device) and executes the program, and controls each component, etc. through the execution of the program such that the function that satisfies a predetermined purpose can be realized. In the present embodiment, the processor included in the control unit 12 corresponds to the first processor.

The storage unit 13 includes, for example, a recording medium such as an erasable programmable ROM (EPROM), a hard disk drive (HDD), and a removable medium. Examples of removable media include disc recording media such as a universal serial bus (USB) memory, a compact disc (CD), a digital versatile disc (DVD), and a Blu-ray (registered trademark) disc (BD). The storage unit 13 can store an operating system (OS), various programs, various tables, and various databases (DB), etc. The storage unit 13 has a user information database 131 and a power generation information database 132.

The user information database 131 stores information (hereinafter referred to as “user information”) related to the user 40 who uses the exercise promotion system. Examples of the user information include a user ID, password, name, contact information, usage history, etc. of the user 40 who has registered the use of the exercise promotion system. The user ID and password in the user information are used for authentication processing such as login to the server 10.

The power generation information database 132 stores information (hereinafter referred to as “power generation information”) related to a power generation record in which the user 40 generates power by exercising using the power generation device 20. The power generation information includes user ID, usage history information, information indicating the total power generation amount, information indicating the power generation amount for each use, information indicating the amount of calories consumed for each use, and worth information assigned as compensation for exercise accompanied by power generation. The worth information is information including a value generated in accordance with the amount of electric power generated (power generation amount).

For example, when the server 10 receives the power generation information from the power generation device 20 by the communication unit 11, the control unit 12 generates worth information corresponding to the power generation amount based on information on the power generation amount included in the power generation information. Then, the server 10 stores the power generation information including the worth information in the power generation information database 132 together with the user ID. As described above, the storage unit 13 stores the user information and the power generation information in association with each other.

Further, the control unit 12 generates a value corresponding to the amount of generated electric power as a value of the worth information. For example, a value indicating the same amount of power as the amount of power generated by the current exercise is generated as the value of the current worth information based on the power generation information received from the power generation device 20. The value indicating the amount of electric power generated here is a value expressed in the same unit as the amount of electric power. As a result, the value of the worth information corresponding to the power generation amount is generated. Then, the value of the worth information that is currently generated is added to the value of the worth information in the corresponding user information. That is, in the power generation information database 132, the value of the worth information that is currently generated is added. Further, the value of the worth information is managed as a value that can be used when electric power is supplied at the charging stand 30 or the like.

### Power Generation Device

The power generation device 20 is a device for the user 40 to move his/her body and perform an exercise accompanied by power generation. The power generation device 20 is not only an exercise device but also a human-powered generator. For example, the power generation device 20 is composed of a treadmill installed in a fitness gym as shown in FIG. 1. When the power generation device 20 is a treadmill, the user 40 can run using the treadmill and generate electric power using the power input by the exercise.

As shown in FIG. 2, the power generation device 20 includes an operation unit 21, an input unit 22, a display unit 23, a communication unit 24, a control unit 25, and a storage unit 26. The communication unit 24, the control unit 25, and the storage unit 26 included in the power generation device 20 are physically the same as the communication unit 11, the control unit 12, and the storage unit 13 included in the server 10.

The operation unit 21 is a unit operated by the user 40 when the user 40 exercises. When the operation unit 21 is operated in response to the exercise of the user 40, the power generation device 20 generates electric power by the kinetic energy input from the operation unit 21. That is, the operation unit 21 is a unit to be operated during exercise depending on the user 40 who exercises, and is a unit where kinetic energy to be converted into electric power is input to the power generation device 20 that generates electric power. The operation unit 21 is connected to power generation means such as a motor so as to be able to transmit power.

For example, when the power generation device 20 is a treadmill, the operation unit 21 is a running belt, and a motor is connected to the running belt so as to be able to transmit power. Therefore, when the user 40 is exercising, the motor generates electric power by the rotational force input from the operation unit 21. This power generation control is carried out by the power generation control unit 251 of the control unit 25. Then, when the kinetic energy of the operation unit 21 is converted into electric power, the generated electric power is stored in a power storage device. The power storage device is electrically connected to the motor. For example, the power generation device 20 may be provided with a power storage device, or the fitness gym in which the power generation device 20 is installed may be provided with a power storage device. Therefore, the electric power generated by the power generation device 20 in accordance with the exercise of the user 40 and stored in the power storage device may be consumed by the power generation device 20, or may be consumed by an electric device in the fitness gym.

The input unit 22 receives input of various types of information when the user 40 exercises using the power generation device 20. For example, the input unit 22 is composed of a keypad, buttons, a touch panel, and the like provided on a console unit (operation panel) of the power generation device 20. Then, the input unit 22 accepts the input of the identification information (user ID) of the user 40 who exercises using the power generation device 20 from now on. The identification information of the user 40 input to the input unit 22 is output from the input unit 22 to the control unit 25.

The display unit 23 is a display that displays various types of information when the user 40 uses the power generation device 20. The display unit 23 may be configured by the same touch panel as the input unit 22. For example, when the power generation device 20 is a treadmill, the input unit 22 and the display unit 23 are integrally provided on the console portion. Then, the power generation device 20 can display a message requesting the input of the user ID on the display unit 23, and request the user 40 to perform an input operation to the input unit 22.

The communication unit 24 transmits and receives information to and from the server 10 via the network NW. The communication unit 24 is controlled by the control unit 25.

The control unit 25 executes various controls by executing the program stored in the storage unit 26. That is, the control unit 25 can function as various processing units. In the present embodiment, the processor included in the control unit 25 corresponds to a second processor.

The control unit 25 includes a power generation control unit 251 and a calculation unit 252.

The power generation control unit 251 executes power generation control when converting the kinetic energy input by operating the operation unit 21 into electric power. In the power generation device 20, the motor is controlled by the power generation control unit 251 such that power can be generated by the input from the operation unit 21.

Further, the power generation control unit 251 measures the amount of electric power generated between the start and the end of the exercise while the user 40 continues the exercise. The power generation control unit 251 can measure the amount of power generated by the current exercise using the power generation device 20. Then, the power generation control unit 251 stores the measured value of the power generation amount in the storage unit 26.

The calculation unit 252 calculates the calories consumed by the exercise using the power generation device 20. The calculation unit 252 can calculate the calorie consumption amount in accordance with the operation amount of the operation unit 21. In addition, the calculation unit 252 calculates the difference between the target calorie consumption and the current calorie consumption.

Further, the control unit 25 can function as a display control unit. At that time, the control unit 25 controls the display content on the display unit 23. The control unit 25 displays various types of information on the display unit 23 based on the operation of the input unit 22 (button operation, touch operation, etc.) by the user 40. The display screen includes a login screen when the user 40 logs in to the exercise promotion system, a screen displaying calories consumption during exercise, a screen displaying the difference between the target calories consumption and the current calories consumption during exercise, and a screen displaying the achievement ratio with respect to the target calories consumption.

The storage unit 26 stores data for the power generation control unit 251 to execute the power generation control. Further, in the storage unit 26, user information of the user 40 using the power generation device 20, information on the power generation amount, and the like are temporarily stored as needed.

The power generation device 20 is not limited to the treadmill, and may be various training machines installed in the fitness gym. For example, examples of the power generation device 20 include a treadmill, a cross-trainer (registered trademark), and an exercise bike machine (indoor cycle, upright bike, recumbent bike).

### Charging Stand

The charging stand 30 is a charging device that supplies electric power to the vehicle 50. For example, the charging stand 30 is connected to the vehicle 50 via a charging cable so as to be able to supply electric power. The charging stand 30 includes an input unit 31, a display unit 32, a communication unit 33, and a control unit 34. The input unit 31, the display unit 32, the communication unit 33, and the control unit 34 included in the charging stand 30 are physically the same as the input unit 22, the display unit 23, the communication unit 24, and the control unit 25 included in the power generation device 20.

The input unit 31 receives an input of the amount of electric power to be charged to the vehicle 50. The display unit 32 is a display that displays the charging amount, the charging time, and the like. The input unit 31 and the display unit 32 may be integrally configured by a touch panel. The communication unit 33 transmits and receives information to and from the server 10 via the network NW. The input unit 31, the display unit 32, and the communication unit 33 are controlled by the control unit 34.

The control unit 34 controls electric power supply when electric power is supplied to the vehicle 50. The control unit 34 can function as various processing units. In the present embodiment, the processor included in the control unit 34 corresponds to a third processor.

The control unit 34 includes a power supply unit 341.

The power supply unit 341 executes charge control to supply the electric power of the external power source to the vehicle 50. When the charging amount is set by operating the input unit 31 in the state where the charging stand 30 and the vehicle 50 are connected so as to be able to supply the electric power, the power supply unit 341 executes control to supply the electric power corresponding to the charging amount to the vehicle 50.

Further, the control unit 34 determines the amount of electric power to be charged based on the worth information received from the server 10 by the communication unit 33. That is, the control unit 34 can charge the vehicle 50 with the amount of electric power corresponding to the value of the worth information.

For example, when the control unit 34 makes a request for use of the worth information from the user 40 by operating the input unit 31, the control unit 34 inquires the server 10 of a request (usage request) for using the worth information. Then, the control unit 34 displays the value of the worth information received from the server 10 on the display unit 32, and displays a screen for confirming with the user 40 whether the electric power is supplied corresponding to the value. Further, when the user 40 operates the input unit 31 to set the value of the worth information to be currently used, the control unit 34 includes the amount of electric power corresponding to the set value as the current charging amount.

### Overall Process Flow

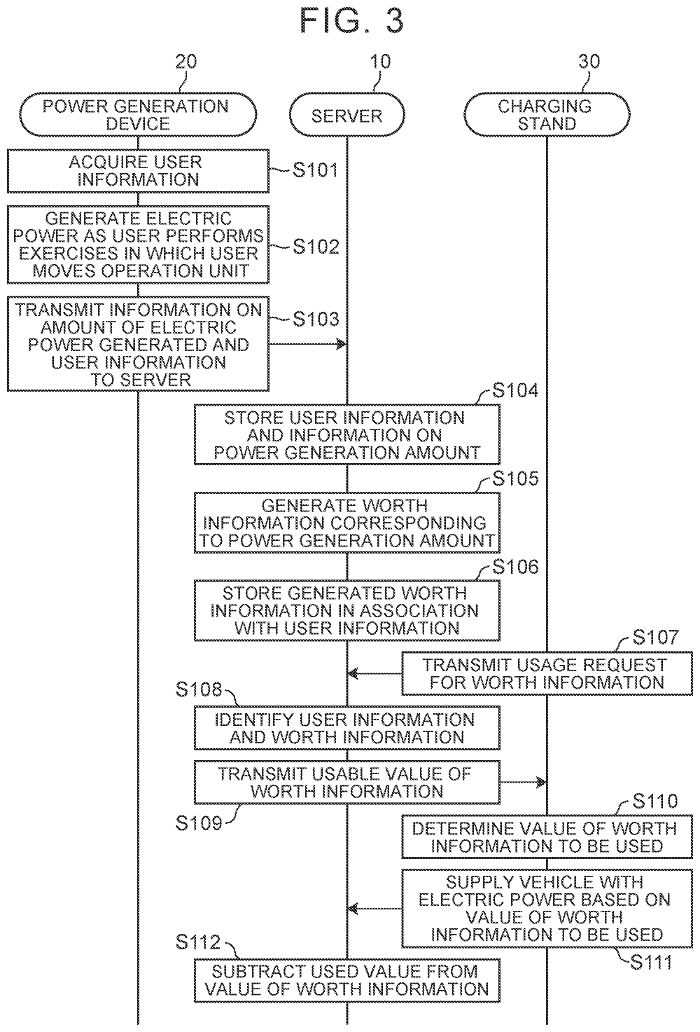

FIG. 3 is a sequence diagram for explaining the overall process flow.

The power generation device 20 acquires the information on the user 40 when the user 40 performs the exercise accompanied by power generation (step S101). In step S101, the user ID information is acquired by operating the input unit 22.

The power generation device 20 generates electric power using the power from the operation unit 21 in a manner such that the user 40 performs the exercise in which the user 40 moves the operation unit 21 (step S102). In step S102, the power generation control by the power generation control unit 251 is executed.

The power generation device 20 transmits the information on the amount of electric power generated by the exercise of the user 40 and the information on the user 40 to the server 10 (step S103). In step S103, when the exercise by the user 40 is completed, information on the amount of electric power generated by the current exercise, information on the calories consumed, and information on the user ID that can identify the user 40 who has generated the electric power are transmitted to the server 10.

When the server 10 receives the information from the power generation device 20, the server 10 stores the information on the user 40 and the information on the power generation amount in the storage unit 13 (step S104). In step S104, the user information is stored in the user information database 131, and the power generation information is stored in the power generation information database 132. At that time, the user information and the power generation information are stored in a manner such that the user ID of the user information corresponds to the user ID of the power generation information.

Further, when the server 10 stores the power generation information, the server 10 generates the worth information corresponding to the power generation amount (step S105). In step S105, the worth information of the value corresponding to the amount of electric power generated by the current exercise is generated by the control of the control unit 12. For example, a value indicating that it is possible to use the same amount of electric power as the amount of electric power generated is generated as the worth information.

Then, the server 10 stores the worth information generated by the process in step S104 in the storage unit 13 in association with the user information (step S106). In step S106, the value of the worth information is managed in association with the user ID. For example, when the value of the worth information is already acquired, the value of the worth information generated in step S105 is added to the value of the worth information on the corresponding user 40 by the process in step S106.

Further, the charging stand 30 transmits the usage request for using the worth information to the server 10 (step S107). In step S107, when the usage request of the worth information is received together with the user ID of the user 40 in response to the operation of the input unit 31 at the time of charging the vehicle 50 with the electric power at the charging stand 30, the charge stand 30 transmits the usage request of the worth information to the server 10.

When the server 10 receives the usage request of the worth information from the charging stand 30, the server 10 identifies the user information and the worth information based on the usage request (step S108). In step S108, the server 10 refers to the storage unit 13 based on the user ID included in the information from the charging stand 30, and identifies the corresponding user information and worth information.

Then, the server 10 transmits a usable value of the worth information to the charging stand 30 based on the identified worth information (step S109). In step S109, the value of the worth information stored in the power generation information database 132 is transmitted to the charging stand 30 as the usable value.

When the charging stand 30 receives the information in response to the usage request of the worth information from the server 10, the charging stand 30 displays the usable value of the worth information on the display unit 32 and determines the value of the worth information specified by the user 40 in the input unit 31 as the value that is to be currently used (step S110). In step S110, for example, whether to consume all the usable values of the worth information in current use or only a part of the usable values of the worth information in current use is determined by the input operation of the input unit 31 by the user 40.

Then, the charging stand 30 supplies the vehicle 50 with the electric power based on the value of the worth information (step S111). In step S111, the charge control is executed in which the value of the worth information is consumed and the amount of electric power corresponding to the value is included in the charging amount. Further, when the power supply to the vehicle 50 is completed, the charging stand 30 transmits, to the server 10, completion information indicating that the power supply consuming the value of the worth information is completed.

When the server 10 receives the information indicating that the power supply is completed from the charging stand 30, the server 10 subtracts the value of the amount used in the current power supply from the value of the worth information (step S112). In step S112, the value determined by the process in step S110 is subtracted from the value of the worth information stored in the power generation information database 132. That is, in step S112, the worth information of the corresponding user 40 is updated. Power Generation Process

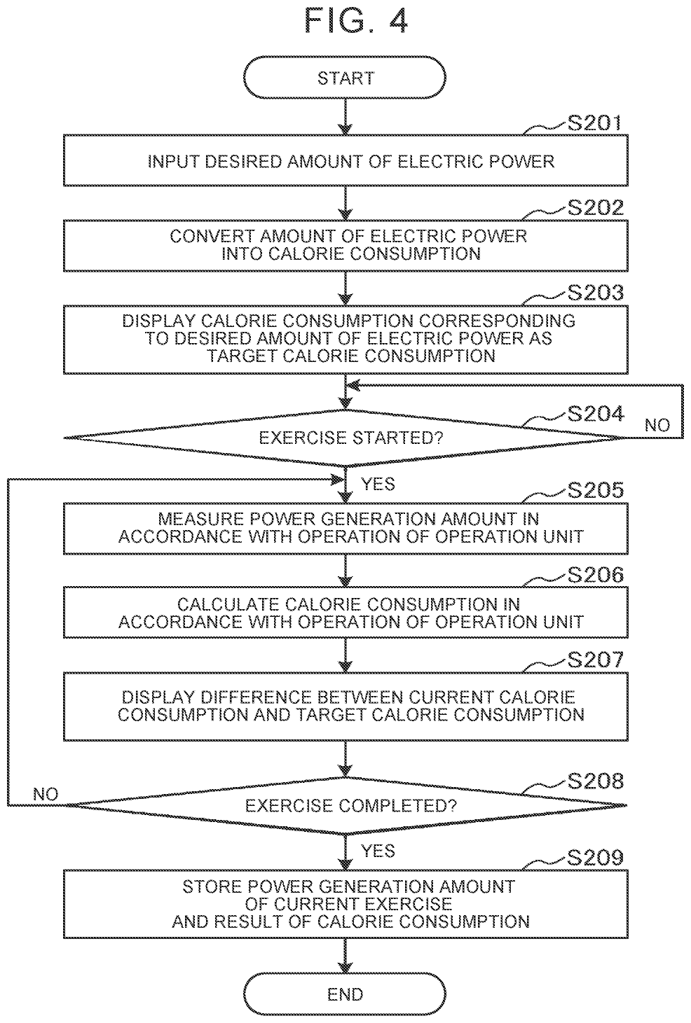

Here, an example of a process flow when the user 40 exercises using the power generation device 20 will be described with reference to FIG. 4. FIG. 4 is a flowchart showing a process flow for the power generation device.

As shown in FIG. 4, the power generation device 20 receives an input of a desired amount of electric power as the input operation to the input unit 22 by the user 40 and as compensation for the current exercise (step S201). In step S201, the input of the target power generation amount is received in the same unit value as the amount of the electric power. In the control unit 25, the amount of electric power input in step S201 is set as the target power generation amount in the current exercise.

Further, the power generation device 20 converts the amount of electric power input in step S201 into calorie consumption (step S202). In step S202, the calculation unit 252 converts the target power generation amount into the target calorie consumption. In the control unit 25, the calorie consumption converted in step S202 is set as the target calorie consumption in the current exercise.

The power generation device 20 displays the calorie consumption converted in step S202 as the target calorie consumption on the display unit 23 (step S203). In step S203, the display control of the control unit 25 displays information including the target calorie consumption and the target power generation amount on the display unit 23.

Then, the power generation device 20 determines whether the exercise by the user 40 has been started (step S204). In step S204, the control unit 25 determines whether the exercise has been started. For example, when the button indicating the start of exercise is operated by the input operation to the input unit 22, the control unit 25 can determine that the exercise using the power generation device 20 has been started. Alternatively, when it is detected that the operation of the operation unit 21 has started, the control unit 25 can determine that the exercise accompanied by power generation has started.

When the exercise by the user 40 has not been started (step S204: No), this control routine returns to step S204.

When the exercise by the user 40 is started (step S204: Yes), the power generation device 20 generates power in accordance with the operation of the operation unit 21 by the user 40, and measures the power generation amount in accordance with the operation amount (step S205). In step S205, the power generation control by the power generation control unit 251 is executed. The control unit 25 measures the power generation amount corresponding to the current exercise as the power generation control starts. The measured power generation amount is stored in the storage unit 26.

Further, the power generation device 20 calculates the calorie consumption in accordance with the operation of the operation unit 21 by the user 40 (step S206). In step S206, the calculation unit 252 calculates the calorie consumption based on the operation amount and the operation time of the operation unit 21. In step S206, the total amount of calories consumed from the start of exercise to the present time is calculated. The calculated calorie consumption is stored in the storage unit 26.

Then, the power generation device 20 displays the difference between the current calorie consumption and the target calorie consumption on the display unit 23 (step S207). In step S207, the difference between the calorie consumption from the start of exercise and the target calorie consumption is displayed by the control of the control unit 25. The calculation unit 252 calculates the difference between the current calorie consumption and the target calorie consumption. Further, the control unit 25 can calculate the ratio of the current calorie consumption to the target calorie consumption and display the ratio as the current achievement rate on the display unit 23.

Further, the power generation device 20 determines whether the exercise by the user 40 is completed (step S208). In step S208, the control unit 25 determines whether the exercise is completed. For example, when the button indicating the end of the exercise is operated by the input operation to the input unit 22, the control unit 25 can determine that the exercise using the power generation device 20 is completed. Alternatively, when a predetermined time has elapsed since the operation of the operation unit 21 is stopped, the control unit can determine that the exercise accompanied by power generation is completed.

When the exercise by the user 40 is not completed (step S208: No), this control routine returns to step S205.

When the exercise by the user 40 is completed (step S208: Yes), the power generation device 20 stores the results of the power generation amount and the calorie consumption in the current exercise in the storage unit 26 (step S209). In step S205, the power generation information from the current exercise is stored in the storage unit 26. As a result of the current exercise, the control unit 25 can display the calorie consumption and the power generation amount on the display unit 23 as actual data. Further, in step S209, the control unit 25 transmits, to the server 10, the power generation information stored in the storage unit 26 as the actual data together with the user ID of the user 40 who has performed the power generation.

Note that, in step S207, the difference between the current power generation amount and the target power generation amount may be displayed on the display unit 23. The calculation unit 252 calculates the difference between the current power generation amount and the target power generation amount. Further, the control unit 25 can calculate the ratio of the current power generation amount to the target power generation amount and display the ratio on the display unit 23 as the current achievement rate.

As described above, according to the embodiment, the user 40 can obtain compensation for exercise by moving his/her body and performing the exercise accompanied by power generation.

In addition, the user 40 can be given the worth information with which the user can receive the power supply as the compensation for the exercise accompanied by power generation. This motivates the users to exercise, and even the users who do not have a habit of exercising can enjoy the joy of moving his/her body through exercising.

Furthermore, when the users who have a habit of exercising exercise at a fitness gym as usual, the users can obtain the worth information as the compensation for the exercise. With this configuration, convenience is improved.

In the process flow illustrated in FIG. 4, the case where the user 40 inputs the desired power generation amount when inputting the target value to the power generation device 20 has been described. However, the present disclosure is not limited to this. That is, the target value may be the amount of electric power or the calorie consumption. For example, in step S201, the target calorie consumption may be input. In this case, step S202 is not executed, and the process proceeds from step S201 to step S203.

Further, in step S201, an example in which the user ID information is acquired by the input operation to the input unit 22 has been described. However, the present disclosure is not limited to this. For example, the power generation device 20 may include a reading unit capable of reading information of an IC tag. The user 40 wears the IC tag, such as a wearable terminal, on his/her body when training in the fitness gym. In this case, the information from the IC tag of the user 40 is read by the reading unit of the power generation device 20. As described above, the user ID can be acquired without being limited to the input operation from the input unit 22.

Further, the vehicle 50 may be either an electric vehicle or a plug-in hybrid vehicle as long as the vehicle 50 can receive the electric power from the external power source, and is not particularly limited.

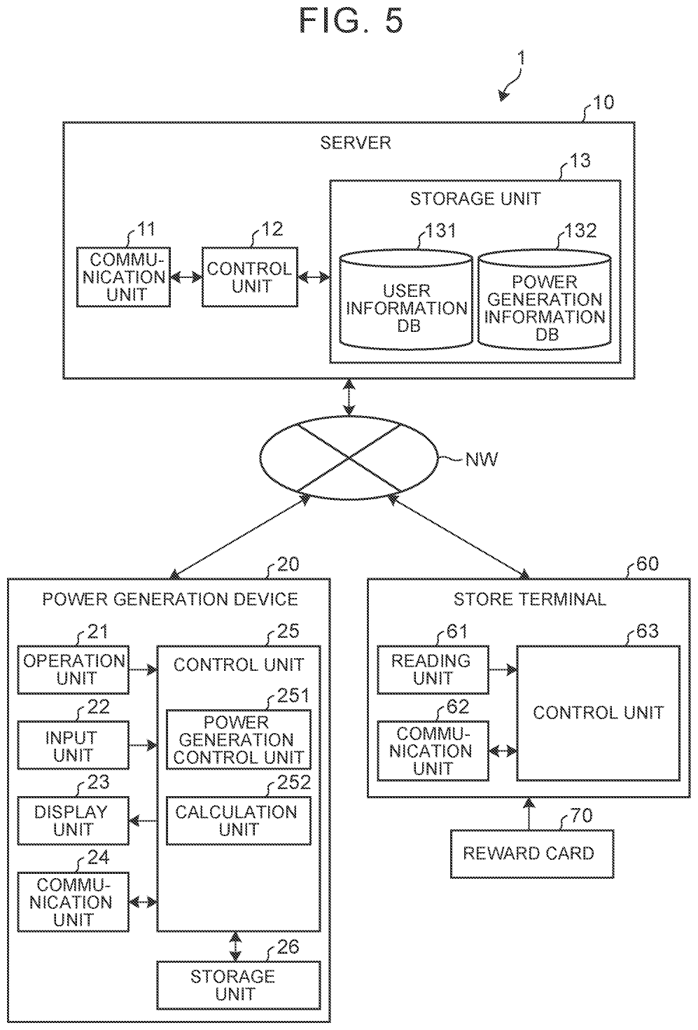

Further, the value of the worth information is not limited to the value indicating the amount of electric power. That is, the range of use of the value of the worth information is not limited to the case where the electric power supply is received. For example, the worth information may be generated as reward points that can be used when the user 40 purchases a product at a store or the like. An example of this modification is illustrated in FIG. 5.

As shown in FIG. 5, the information processing system 1 of the modification is configured to include a store terminal 60. In this modification, when the control unit 12 of the server 10 generates the value of the worth information, the control unit 12 generates reward points corresponding to the power generation amount based on information indicating the power generation amount that is included in the power generation information. Then, the generated reward points are stored in the power generation information database 132 as the value of the worth information. Therefore, as the usage request, it is possible to make a request for using the reward points as the value of worth information.

The store terminal 60 is a cash register terminal set in the store. The store terminal 60 includes a reading unit 61, a communication unit 62, and a control unit 63. The communication unit 62 and the control unit 63 included in the store terminal 60 are physically the same as the communication unit 11 and the control unit 12 included in the server 10.

The reading unit 61 is a scanner capable of reading the user information. For example, information of a reward card 70 owned by the user 40 is read by the reading unit 61. When reading the information, the reward card 70 and the reading unit 61 may be in contact with each other or may not be in contact with each other. The information read from the reward card 70 includes identification information (user ID) that can identify the user 40. Further, the reading unit 61 may read information of a smartphone owned by the user 40, instead of the reward card 70.

The control unit 63 controls a payment process when the user 40 purchases a product at the store. The control unit 63 can function as various processing units. In the present embodiment, the processor included in the control unit 63 corresponds to the third processor.

For example, when the control unit 63 receives the usage request of the worth information from the user 40 as the user 40 indicates an intention at the time of making a payment for the product, the control unit 63 inquires the server 10 of the request for using the worth information. At that time, the control unit 63 transmits the usage request of the worth information to the server 10 together with the user ID acquired by the reading unit 61. This usage request requires that the amount of reward points be deducted from the payment amount at the time of purchasing the product.

In the server 10, the user information based on the user ID is identified in response to the usage request from the store terminal 60, and the value of the worth information associated with the user information is also identified. The value of the worth information identified is the value shown as the reward points. Then, the server 10 transmits the value indicated by the reward points to the store terminal 60 as the usable value in response to the usage request.

When the store terminal 60 receives the information in response to the usage request of the worth information from the server 10, the usable value of the worth information can be displayed on the display as a value indicating the reward points. Then, the value of the worth information specified by indication of the intention of the user 40 is determined as the reward points to be used in the current purchase. The control unit 63 executes a consumption process using the determined reward points.

Note that, in the modification, the store terminal 60 has been described as an example. However, a configuration in which the usage request of the worth information is transmitted from the smartphone, instead of the store terminal 60, may be adopted. Further, the system configuration may include both the store terminal 60 and the charging stand 30. In this case, the server 10 can convert the value of the worth information into the corresponding value in response to various usage requests.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. An information processing system, comprising:
a server including a first processor provided with hardware; and
a power generation device including a second processor provided with hardware, wherein:
the second processor executes power generation control that converts, into electric power, kinetic energy generated as a user operates an operation unit of the power generation device, and outputs, to the server, power generation information indicating a power generation amount generated by power generation under the power generation control; and
the first processor
identifies the power generation information and user information indicating the user who operates the operation unit for the power generation of the power generation information, and
assigns worth information indicating a worth corresponding to the power generation amount with respect to the identified user information.

2. The information processing system according to claim 1, wherein the first processor generates the worth information in accordance with the power generation information from the power generation device.

3. The information processing system according to claim 2, further comprising an external terminal including a third processor provided with hardware, wherein:
the server further includes a storage device;
the storage device stores the user information, the power generation information, and the worth information in association with each other;
the third processor outputs a usage request for using a value of the worth information to the server; and
the first processor
refers to the storage device in response to the usage request, and identifies the user information for the usage request, and
outputs, to the external terminal, the value of the worth information associated with the identified user information as a usable value.

4. The information processing system according to claim 3, wherein:
the third processor
executes a consumption process using the value of the worth information based on the usable value, and
outputs information related to the consumption process to the server; and
the first processor refers to the storage device in accordance with the information related to the consumption process and subtracts the value of the worth information in the corresponding user information.

5. The information processing system according to claim 3, wherein:
the external terminal is a charging device that supplies electric power to an electric vehicle;
the third processor outputs, to the server, the usage request for using the value of the worth information as electric power; and
the first processor
generates the value of the worth information as a value indicating an amount of electric power corresponding to the power generation amount, and
outputs, to the charging device, the value of the worth information associated with the identified user information as the value indicating the amount of electric power.

6. The information processing system according to claim 5, wherein:
the third processor
acquires identification information with which the user is identifiable when electric power is supplied, and
outputs the usage request to the server together with the identification information; and
the first processor identifies the user information based on the identification information.

7. The information processing system according to claim 5, wherein the third processor executes a consumption process using the value of the worth information as the value indicating the amount of electric power.

8. The information processing system according to claim 3, wherein:
the external terminal is a store terminal installed in a store;
the third processor outputs, to the server, the usage request for using the value of the worth information as a reward point; and
the first processor
generates the value of the worth information as the reward point corresponding to the power generation amount, and
outputs, to the store terminal, the value of the worth information associated with the identified user information as a value indicating the reward point.

9. The information processing system according to claim 8, wherein:
the third processor
acquires identification information with which the user is identifiable when the reward point is used, and
outputs the usage request to the server together with the identification information; and
the first processor identifies the user information based on the identification information.

10. The information processing system according to claim 8, wherein the third processor executes a consumption process using the value of the worth information as the value indicating the reward point.

11. The information processing system according to claim 1, wherein:
the power generation device further includes a display; and
the second processor displays current calorie consumption with respect to target calorie consumption indicating calorie consumption that the user desires to consume by an operation of an operation unit on the display based on the target calorie consumption.

12. The information processing system according to claim 11, wherein the second processor:
converts, when the user inputs a value indicating an amount of electric power that the user desires to generate by the operation of the operation unit, a target power generation amount for the input value into target calorie consumption; and
displays the target calorie consumption converted on the display.

13. A server, comprising a processor provided with hardware, wherein the processor:
identifies, for a power generation device that converts kinetic energy generated as a user operates an operation unit into electric power, power generation information indicating a power generation amount generated by the power generation device and user information indicating the user who operates the operation unit for the power generation of the power generation information; and
assigns worth information indicating a worth corresponding to the power generation amount with respect to the identified user information.

14. The server according to claim 13, wherein the processor generates the worth information in accordance with the power generation information from the power generation device.

15. The server according to claim 14, further comprising a storage device, wherein:
the storage device stores the user information, the power generation information, and the worth information in association with each other; and
the processor
identifies the user information corresponding to a usage request for using a value of the worth information when the usage request is input from an external terminal, and
outputs, to the external terminal, the value of the worth information associated with the identified user information as a usable value.

16. The server according to claim 15, wherein the processor refers to the storage device and subtracts the value of the worth information in the corresponding user information in accordance with information related to a consumption process in which the external terminal uses the value of the worth information.

17. The server according to claim 15, wherein:
the external terminal is a charging device that supplies electric power to an electric vehicle; and
the processor
generates the value of the worth information as a value indicating an amount of electric power corresponding to the power generation amount,
identifies the user information corresponding to the usage request for using the value of the worth information as electric power when the usage request is input from the charging device, and
outputs, to the charging device, the value of the worth information associated with the identified user information as the value indicating the amount of electric power.

18. The server according to claim 15, wherein:
the external terminal is a store terminal installed in a store;
the processor
generates the value of the worth information as a reward point corresponding to the power generation amount,
identifies the user information corresponding to the usage request when the usage request for using the value of the worth information as the reward point is input from the store terminal, and
outputs, to the store terminal, the value of the worth information associated with the identified user information as a value indicating the reward point.

19. A program that causes a processor provided with hardware to execute:
identification of, for a power generation device that converts kinetic energy generated as a user operates an operation unit into electric power, power generation information indicating a power generation amount generated by the power generation device and user information indicating the user who operates the operation unit for the power generation of the power generation information; and
assignment of worth information indicating a worth corresponding to the power generation amount to the identified user information.

20. The program according to claim 19, causing the processor to execute generation of the worth information in accordance with the power generation information from the power generation device.
